(19) United States
(12) Patent Application Publication
(10) Pub. No.: US 2025/0285508 A1
(43) Pub. Date: Sep. 11, 2025

(54) GAMING DEVICE, METHODS, AND COMPUTER PROGRAM FOR PROVIDING SELECTABLE GAME PLAY OPTIONS

(71) Applicant: Aristocrat Technologies Australia Pty Limited, North Ryde (AU)

(72) Inventor: Colin Fong, Penshurst (AU)

(21) Appl. No.: 18/675,856

(22) Filed: May 28, 2024

(30) Foreign Application Priority Data
Mar. 8, 2024 (AU) 2024201560

(51) Int. Cl. G07F 17/32

(52) U.S. Cl. CPC G07F 17/326; G07F 17/3211

(57) ABSTRACT

A gaming device including an electronic display(s) and an input device. The input device includes a first set and second set of input elements operable to select a first or second game play option, respectively. The gaming device also includes a game controller in communication with the electronic display and the input device. The game controller includes a processor(s), and a memory device(s) storing instructions that, when executed by the processer, cause the game controller to control the electronic display to display an evaluation area including a plurality of symbol positions based on the selected, first or second game play option. The game controller also selects symbols, based on symbol data in the memory device, for display in one of the plurality of the symbol positions included in the evaluation area, and evaluates the selected symbols for winning combinations based on the selected, first or second game play option.

### CROSS REFERENCE TO RELATED APPLICATIONS

This application claims the benefit of priority to Australia Patent Application No. 2024/201560, filed Mar. 8, 2024, the contents of which are hereby incorporated by reference herein in its entirety.

### TECHNICAL FIELD

The field of disclosure relates generally to gaming devices, and more specifically, to gaming devices, methods, and computer programs for operating gaming devices that provide selectable game play options to alter an electronic game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

Some EGMs are deployed in conjunction with player tracking systems, such as the OASIS® or System 7000® system manufactured by Aristocrat® Technologies, Inc with a player tracking interface deployed at the respective EGM, for example, in the form of a player marketing module or “console” to enable the player to enter a player loyalty card. Some player marketing modules enable a player to reserve an EGM while taking a break. In an example, a player presses a reserve button and then removes their player loyalty card. The EGM is then locked until the player reinserts their player loyalty card into the console or a console associated with a second EGM in which case the player tracking system transfers the credits to the second EGM.

### BRIEF DESCRIPTION

An example embodiment describes a gaming device that includes at least one electronic display, an input device including a first set of input elements operable to select a first game play option, and a second set of input elements operable to select a second game play option wherein the second game play option is distinct from the first game play option, and a game controller in communication with the at least one electronic display and the input device. The game controller includes at least one processor, and a memory device for storing instructions that, when executed by the processer, cause the game controller to: control the at least one electronic display to display an evaluation area including a plurality of symbol positions based on one of the selected, first game play option or the selected, second game play option; select symbols, based on symbol data in the memory device, for display in one of the plurality of the symbol positions included in the evaluation area; and evaluate the selected symbols for winning combinations based on one of the selected, first game play option or the selected, second game play option.

Another example embodiment describes a computer-implemented method of electronic gaming. The method is implemented on an electronic gaming device. The method including displaying, via at least one electronic display of the electronic gaming device, an evaluation area including a plurality of symbol positions based on one of a selected, first game play option or a selected, second game play option wherein the second game play option is distinct from the first game play option; displaying symbols, based on symbol data, in one of the plurality of the symbol positions included in the evaluation area; and evaluating the selected symbols for winning combinations based on one of the selected, first game play option or the selected, second game play option.

Another example embodiment describes a non-transitory computer-readable storage medium with symbol data and instructions stored thereon that in response to execution by at least one processor, cause the at least one processor to: control at least one electronic display to display an evaluation area including a plurality of symbol positions based on one of a selected, first game play option or a selected, second game play option wherein the second game play option is distinct from the first game play option; control the at least one electronic display to display symbols based on the symbol data in one of the plurality of the symbol positions included in the evaluation area; and evaluate the selected symbols for winning combinations based on one of the selected, first game play option or the selected, second game play option.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 is a schematic diagram of an EGM display and a first example button deck.

FIG. 4 is a flow chart of an example method for selecting symbols from reel strips.

FIG. 5 is a schematic diagram of a second example button deck.

FIG. 6 illustrates the options selectable with the button deck of FIG. 5;

FIG. 7 is a schematic diagram of a third example button deck.

FIG. 8 illustrates the options selectable with the button deck of FIG. 7;

FIG. 9 is a schematic diagram of a fourth example button deck.

FIG. 10 is a schematic diagram of a fifth example button deck.

FIG. 11 is a schematic diagram of a sixth example button deck.

FIG. 12 is a schematic diagram of a fourth example button deck.

### DETAILED DESCRIPTION

Example embodiments are described herein where gaming devices incorporate an input device that has a first set of input elements operable to select a number of symbol positions (e.g., a predefined arrangement of a number of rows and columns of symbol positions) from at least a first number of symbol positions and a second, higher number of symbol positions, and a second set of input elements operable to select an evaluation of the selected number of symbol positions from at least a first evaluation and a second evaluation different from the first evaluation. The gaming device carries out a play of the game based on the selection including by selecting symbols for the selected symbol positions and evaluating the selected symbols based on the selected evaluation.

The ability to provide selectable different game play options on a gaming device provide additional convenient aspects to the gaming device. By providing these enhancements, a player is able to more easily select certain options by selecting a physical or virtual button for changing or altering how an electronic game is played on a gaming device. For example, the size of a game play matrix may be altered by selecting one of many selectable buttons. Or the number of reels that are included within the award evaluation may be alterable. In addition, by providing these selectable options, the electronic game provides increased variability and flexibility in overall game play, as well as potentially increasing chances of achieving winning outcomes for the game. The selectable game play options can include selecting the size or number of symbol positions that are played or available during the game. The number of symbol positions can include a selectable number of rows and/or columns of symbol positions that display symbols for the game. Additionally, the selectable game play options include win evaluations relating to a selectable number of reels included within and/or formed from the plurality of symbol positions. The reels can be formed as each column of the plurality of symbol positions. Each win evaluation can be associated with a number of reels, and each symbol or symbol position included in the reel associated with the selected win evaluation can be compared to predefined reference symbol positions to evaluate or identify winning combinations. The more reels evaluated, the more symbols/symbol positions are compared to the predefined reference symbol positions, and thus, a greater chance of identifying a winning combination. Additionally, where the number of reels incorporates all symbol positions, every single symbol position is evaluated to identify a winning combination. The selectable game play options can further include a selectable number of pay lines for the plurality of symbol positions that can result in a winning combination. Further, the selectable game play option can include bet multipliers, that can increase the overall payout for a winning combination by a factor of “x.” Moreover, various combinations of the selectable game play options may be implemented to further increase the variability and flexibility in presenting winning outcomes of the game. Furthermore, and through use of input device (e.g., buttons), players of the gaming machine can follow, interact, determine game play options, and/or feel excited about the potential for winning the game.

The example devices, methods, and computer program products of the present disclosure represent a technical improvement in the field of electronic gaming. Technical improvements represented by the present disclosure include: (i) presenting Class II and Class III games with interactive capabilities where players can alter the game play and game outcome with selectable game play options; (ii) adjusting evaluation areas or game play areas based on the selectable game play options; (iii) applying one or more game play options to alter the game in varying combinations concurrently; (iv) increasing the flexibility and variability in game play using the selectable game play options to facilitate increasing player interest and excitement; and/or (v) displaying various winning outcomes and combinations that are achieved through the player interacting with and selecting game play options. Additional and/or alternative technical improvements may exist.

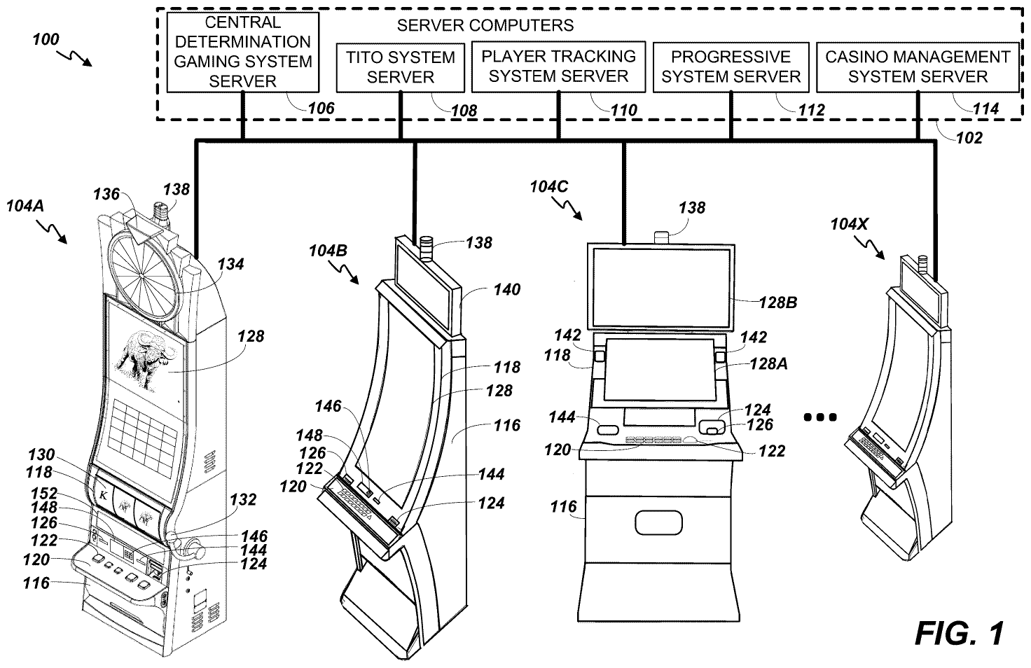

FIG. 1 illustrates several different models of EGMs which may be networked to various gaming related servers. The present embodiments can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present embodiments may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card. In some other examples, a digital wallet can be used to store funds, such that funds can be transferred to and from the digital wallet. In some examples, an application on a user's mobile device (e.g., a cell phone) can communicate with the

In some embodiments, a player tracking card reader 144, and/or a transceiver for wireless communication with a player's smartphone (e.g., for communicating with loyalty application or digital wallet application on the player's smartphone. In some embodiments, a keypad 146, and/or an illuminated display 148 for reading, receiving, entering, and/or displaying player tracking information is provided in gaming device 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

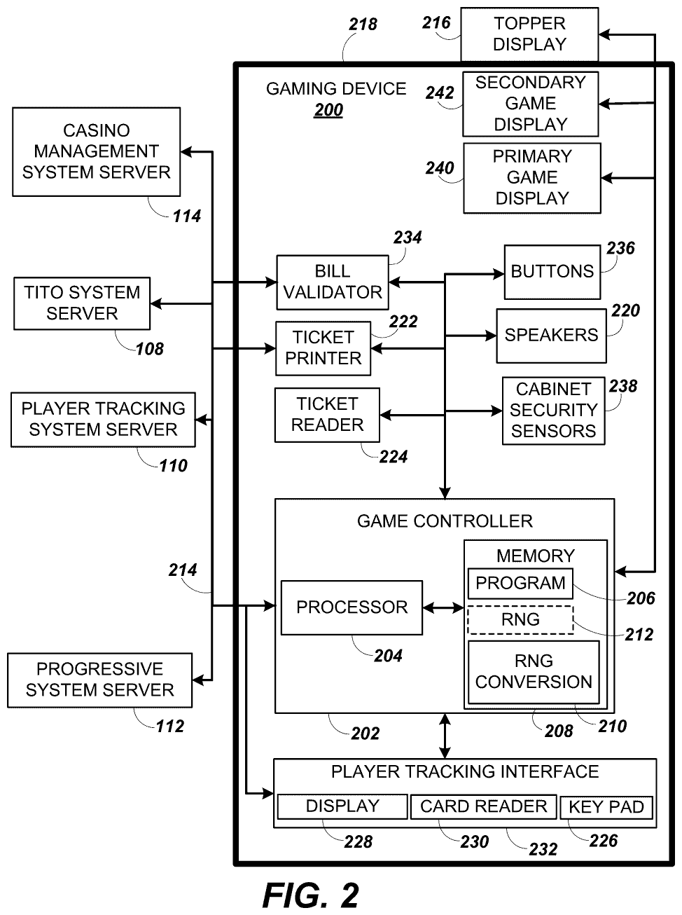

Many or all the above-described components can be controlled by circuitry (e.g., a gaming controller) housed inside the main cabinet 116 of the gaming device 104A, the details of which are shown in FIG. 2.

Note that not all gaming devices suitable for implementing the present embodiments necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play, or any other information or media desired by the game designer or operator.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (e.g., a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® or System 7000® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

In the above examples, the player tracking interface and TITO interfaces are described as being part of the EGM. In other implementations, a player interface module, sometimes referred to as a console, is provided separately to the EGM to implement this functionality. For example, to enable EGMs of many different manufacturers and ages to be integrated to a common system such as Aristocrat's Oasis® or System 7000 system. Such consoles can have the visual appearance of being integrated with EGMs by being fitted within casings designed to fit to the EGMs to which they are connected.

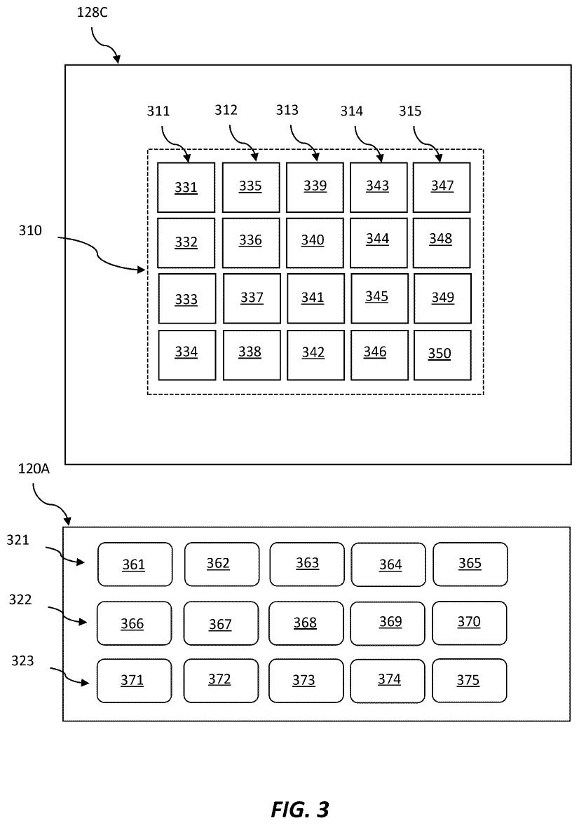

FIG. 3 is a schematic diagram of a main display 128C and an input device in the form of a first example button deck 120A. FIG. 3 is not to scale and is to illustrate concepts employed in the embodiments. Other elements that may be present as part of button deck or main display are left out for clarity.

Main display 128C is an electronic display and includes an outcome evaluation area 310, shown to include five columns 311-315 of symbol positions 331-350. As discussed herein, the number of symbol positions 331-350 will vary based on player selections of game play options. When the gaming device is operated in order to conduct a play of a game, symbols are selected by processor 204 from reel strips (symbol data) stored in memory 208 (see, FIG. 2). In some examples, symbols included in symbol positions 331-350 that will not form part of the outcome to be evaluated will also be displayed on main display 128C, outside the outcome evaluation area 310. In some examples, visual effects are used to indicate that such symbols/symbol positions 331-350 will not be evaluated—for example, a boundary or greying out such symbols.

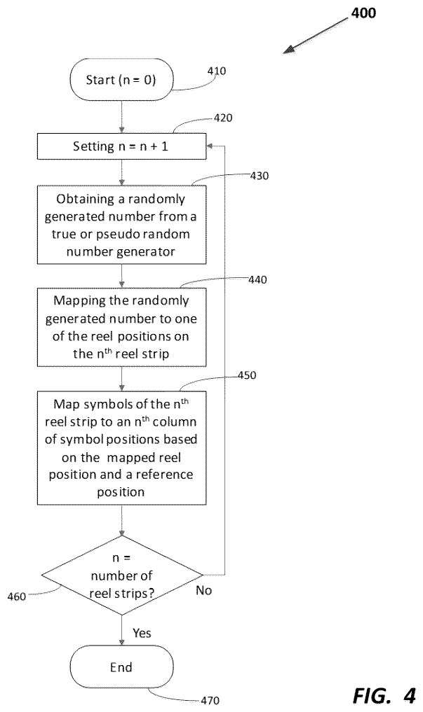

FIG. 4 is a flow chart of an example method 400 carried out by the processor 204 to select symbols from reel strips. At step 410, the processor 204 (see, FIG. 2) starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip (e.g., leftmost). At step 430, the processor obtains a randomly generated number from a true or pseudo random number generator 212 (see, FIG. 2). At step 440 the processor maps the generated number to one of the reel positions of an nth reel strip. In an example, where there are five-reel strips, in the first iteration, this is the first reel strip and the last iteration, this is the fifth reel strip. To map the generated number to one of the reel positions, the possible values that can be returned from the RNG 212 are divided into ranges and associated with specific ones of the reel strip positions of the reel strips. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to an nth column of symbol positions based on the mapped reel position and a reference position. In an example, the reference position is the bottom position of the symbol positions of each column of symbol positions. The reference symbol position is the bottom symbol position selected reel position, and the symbol at this position is mapped to the bottom symbol position of the column. The other symbol positions are then mapped from neighboring positions on the reel strip such that the mapped symbols are from a contiguous group of symbols of the reel strip.

At step 460, the processor 204 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Where as described above, the number of symbol positions is different, there will also be a mapping to a reference position, which may be different, where a different number of symbols will be mapped to the different number of symbol positions. In some examples, symbol data in memory 208 may define a plurality of sets of reel strips and an association with respective arrangements of symbol positions such that the set of reel strips used by processor 204 depends on the selection of a number of symbol positions. In some examples, the use of different sets of probabilities enables the control of the relative probabilities of game outcomes across the different selections of numbers of symbol positions.

After the symbols of all reel strips have been mapped to symbol position, at step, the processor 204 controls display 240 to display them at the symbol positions 331-350.

Returning to the non-limiting example shown in FIG. 3, first button deck 120A is an electronic display with an overlaid or integrated touch panel operable by the user to make selections of game play options. Button deck 120A can be mounted to the cabinet of the gaming device below the main display 128C in a generally horizontal orientation. Processor 204 can control the electronic display of the button deck 120A to display a plurality of input elements in the form of virtual buttons 361-375. The virtual buttons 361-375 are arranged in three rows 321-323, which provide three sets of five input elements (e.g., virtual buttons). In some examples, button deck 120A may be provided by input elements in the form of physical buttons. Physical buttons may include small electronic displays in order to enable the physical buttons to be reconfigured. In this example, there is a dedicated input element (e.g., physical buttons) for each selectable game play option in the sense that a specific touchable input element is provided for each game play option. In other examples, there may be fewer input elements than options, for example, one or more input elements to scroll through selectable game play options and confirm selections, as discussed herein.

While FIG. 3 shows three rows 321-323, providing three sets of five input elements (e.g., virtual buttons 361-365, 366-370, 371-375), embodiments may provide different numbers of input elements, provided they are operable by a user to make a number of selections that control how a game is played on the gaming device 200.

In an embodiment, first row 321 providing a first set of input elements (e.g., virtual buttons 361-365) has at least two input elements operable to select game play options. In the example, the selectable game play options include different numbers of symbol positions 331-350, so that there is at least a first number of symbol positions and a second, higher number of symbol positions. The different numbers of symbol positions are provided by different arrangements of symbol positions which specify the number and position of the symbol positions. Each arrangement of symbol positions has a plurality of columns of symbol positions, such as the five columns 311-315, and at least one arrangement has at least one additional symbol position in at least one column in order to provide a different number of symbol positions. Different arrangements include different numbers of rows of symbol positions in order to provide a different number of symbol positions as illustrated by examples below. Additionally, and in some examples, different columns may have different numbers of symbol positions.

In an embodiment, at least a second set 322 of input elements (e.g., virtual buttons 366-370) is associated with a distinct game play option including, for example, at least two different evaluations of the symbols selected for the chosen number of symbol positions 331-350. Examples of different evaluations include different numbers of pay lines or different ways to win evaluations.

Pay lines are defined by one symbol position from each column of symbol positions and awards are determined, for example, based on a number of a same symbol selected on an active pay line. For example, a pay table in memory 208 may define awards for winning combinations such as three, four or five of a defined symbol on a pay line.

Ways to win evaluations are differentiated from pay lines in that they involve evaluation of more than one symbol position 331-350 of at least one column 311-315. In an example, the different ways to win evaluations depend on a number of selected columns with all symbol positions 331-334 of a first column 311 being evaluated and a defined or reference symbol position (e.g., symbol positions 338, 342, 346, 350) of each unselected column (e.g., columns 312-315) being evaluated. Referring to FIG. 3. four symbol positions would be evaluated for each selected column and one symbol for each unselected column, such that selecting an evaluation corresponding to selecting two columns will result in 4×4×1×1×1=16 ways to win. In some examples, the number of columns 311-315 selected is referred to as a number or reels because each column 311-315 corresponds to a reel strip as described in relation to FIG. 4. In this context, selection of a reel refers to selecting evaluation of the symbols chosen from that reel.

In a non-limiting example, a third set 323 of input elements (e.g., virtual buttons 371-375) are operable to select another, distinct game play option. In the example, the selectable game play option can include, but is not limited to, a bet multiplier from at least a first bet multiplier and a second, larger bet multiplier. For example, bet multipliers may include ×1, ×2, ×3, ×5 or ×10 bet multipliers. The bet multiplier is applied to the wager amount corresponding to the selected evaluation and number of symbol positions. The bet multiplier is also applied to the award amounts defined in the pay table.

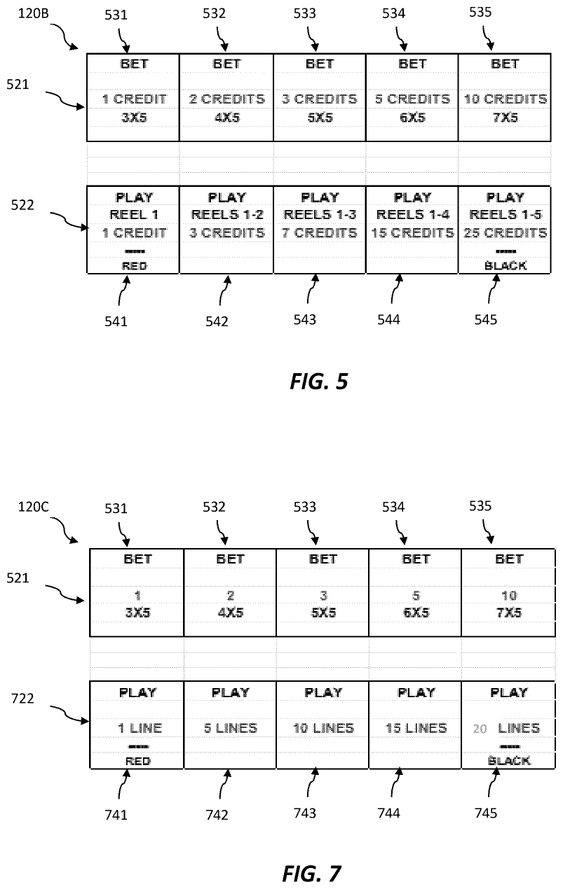

FIG. 5 is a schematic diagram of a second button deck 120B, including two sets 521, 522 of five virtual buttons 531-535, 541-545. In an example, first set 521 of virtual buttons 531-535 corresponds to selecting a first game play option including different arrangements of symbol positions 331-350 (see, FIG. 3); specifically, arrangements with different numbers of rows of symbol positions (e.g., 3×5, 4×5, 5×5, etc.). Additionally, different wager amounts (e.g., 1 credit, 2 credits, etc.) are associated with each arrangement. In the example shown in FIG. 5, virtual button 531 corresponds to a selection of a game to be played with three rows and five columns of symbol positions (3×5) for a wager of 1 credit; virtual button 532 corresponds to a selection of four rows and five columns of symbol positions (4×5) for a wager of 2 credits; virtual button 533 corresponds to a selection of five rows and five columns of symbol positions (5×5) for a wager of 3 credits; virtual button 534 corresponds to a selection of six rows and five columns of symbol positions (6×5) for a wager of 5 credits; and virtual button 535 corresponds to a selection of seven rows and five columns of symbol positions (7×5) for a wager of 10 credits.

Second set 522 of virtual buttons 541-545 corresponds to selecting a second, distinct game play option including different ways to win evaluations. In an example, the ways to win are evaluated from left to right, and the different ways to win evaluations are expressed as the reel or group of reels to be evaluated (e.g., Reel 1, Reels 1-2, Reels 1-3, etc.). Different wager amounts are associated with each selectable win evaluation. Additionally, the amount wagered for the selected win evaluation is multiplied by the amount wagered for the selected arrangement, as determined using virtual buttons 531-535, to obtain a total wager amount that will be deducted from the credit meter for a play of the game. While not shown in FIG. 5, a further button, often labelled as a PLAY button, may be provided to initiate play of the game. In some examples, the button may be pressed to initiate a further play of the game with the last specified wager.

In this example, virtual button 541 corresponds to a selection that the first (e.g., leftmost) reel will have all symbol positions evaluated with the reference symbol position (e.g., bottom position of the symbol positions) evaluated for other reels for a wager of 1 credit; virtual button 542 corresponds to a selection that the first and second reels will have all symbol positions evaluated for a wager of 3 credits; virtual button 543 corresponds to a selection that the first, second and third reels will have all symbol positions evaluated for a wager of 7 credits; virtual button 544 corresponds to a selection that the first, second, third and fourth reels will have all symbol positions evaluated for a wager of 15 credits; and virtual button 545 corresponds to a selection that the first, second, third, fourth and fifth reels (all reels) will have all symbol positions evaluated for a wager of 25 credits. In an example where a user selects both virtual button 535 and virtual button 545 during a play of the game, a total of 250 credits will be deducted from the credit meter (e.g., 10 credits×25 credits=250 credits).

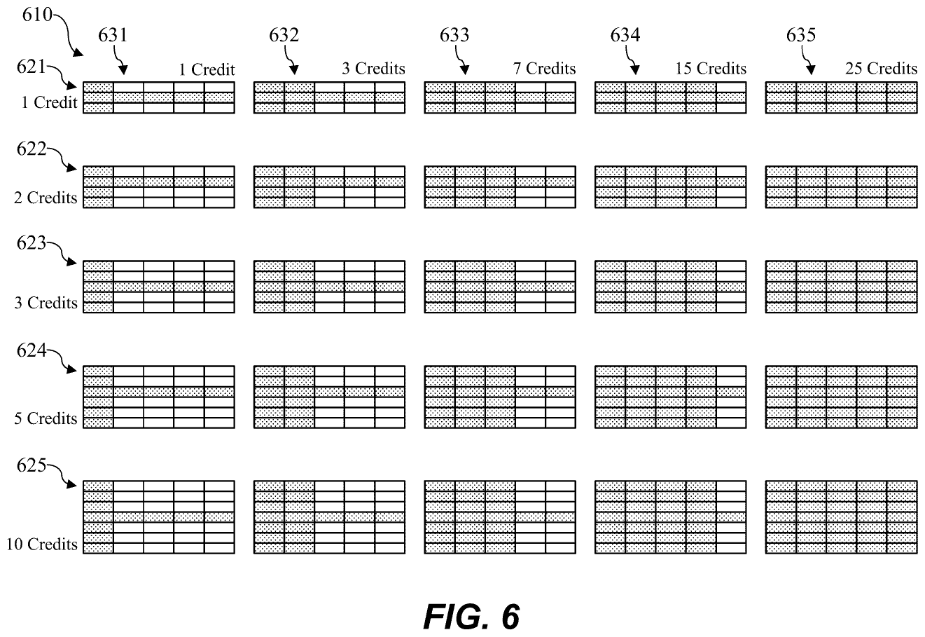

FIG. 6 illustrates the available game play options 610 and ways in which the player can configure the processor 204 (see, FIG. 2) to carry out execution of the game program code, as selected with the button deck 120B of FIG. 5. In FIG. 6, each row 621-625 represents a selection of an arrangement of symbol positions 331-350 (see, FIG. 3) and each column 631-635 represents a number of reels that will be evaluated. The shading in FIG. 6 shows which symbol positions 331-350 will be evaluated based on the combined selection of a number of symbol positions 331-350 and a win evaluation. Specifically, first row 621 corresponds to a selection of a 3×5 arrangement of symbol positions 331-350 for a wager of 1 credit, as selected by virtual button 531 in FIG. 5; second row 622 corresponds to a selection of a 4×5 arrangement for a wager of 2 credits, as selected by virtual button 532 in FIG. 5; third row 623 corresponds to a selection of a 5×5 arrangement for a wager of 3 credits, as selected by virtual button 533 in FIG. 5; fourth row 624 corresponds to a selection of a 6×5 arrangement for a wager of 5 credits, as selected by virtual button 534 in FIG. 5; and fifth row 625 corresponds to a selection of a 7×5 arrangement for a wager of 10 credits, as selected by virtual button 535 in FIG. 5.

Similarly, first column 631 corresponds to a selection that the first (leftmost) reel will have all symbol positions evaluated for a wager of 1 credit, as selected by virtual button 541 in FIG. 5; second column 632 corresponds to selection of first and second reels (e.g., two reels) for a wager of 3 credits, as selected by virtual button 542 in FIG. 5; third column corresponds to a selection of the first, second and third reels for a wager of 7 credits, as selected by virtual button 543 in FIG. 5; fourth column 634 corresponds to a selection of the first, second, third and fourth reels for a wager of 15 credits, as selected by virtual button 544 in FIG. 5; and fifth column 635 corresponds to a selection of first, second, third, fourth and fifth reels (all reels) for a wager of 25 credits, as selected by virtual button 545 in FIG. 5. In the example shown in FIG. 6, the shading of the second row of symbol positions in each row 621-625 and column 631-635 represents the reference symbol position, as discussed herein.

Accordingly, gaming device 200 provides a wide variety of selectable options that affect how many symbols processor 204 selects for symbol positions and the win evaluation of those symbols. In this example, the processor 204 selects from one of five symbol position arrangements that provide a range of options between fifteen and thirty-five symbols and the evaluations vary from three ways to win for a total wager of 1 credit (first row, first column) to 16807 ways to win (seventh row, fifth column) for a total wager of 250 credits. It will be appreciated that the reel strips associated with these options in symbol data may be varied relative to one another in order to provide a substantially consistent return to player across the selectable options.

An advantage of such variety is that it enables varied game play based on the number of symbol positions and the number of reels selected as the underlying volatility can be adjusted regardless of the size of the matrix and the number of reels evaluated while maintaining a similar return to player being delivered in the same game.

FIG. 7 is a schematic diagram of a third button deck 120C, including two sets 521, 722 of five virtual buttons 531-535, 741-745. In the example shown in FIG. 7, the first set 521 of virtual buttons 531-535 corresponds to selecting different arrangements of symbol positions and offers the same game play options as shown in FIG. 5 for the same wager amounts.

In an example, second set 722 of virtual buttons 741-745 corresponds to selecting a second, distinct game play option including different numbers of pay lines to be evaluated per credit wagered to select an arrangement of symbol positions 331-350 (see, FIG. 3). That is, the number of pay lines evaluated is linearly related to the amount wagered to obtain a respective arrangement of symbol positions (e.g., 3×5, 4×5, etc.) as determined by the selection of one of virtual buttons 531-535 of first set 521, and excluding any bet multiplier that may be applied in other examples.

In this example, virtual button 741 corresponds to a selection of one pay line per credit wagered on the selected arrangement (e.g., 3×5, 4×5, etc.); virtual button 742 corresponds to a selection of five pay lines per credit wagered on the selected arrangement; virtual button 743 corresponds to a selection of ten pay lines per credit wagered on the selected arrangement; virtual button 744 corresponds to of fifteen pay lines per credit wagered on the selected arrangement; and fifteenth virtual button 745 corresponds to a selection of twenty pay lines per credit wagered on the selected arrangement.

Third button deck 120C enables selection of twenty-five different options for configuring how the gaming device 200 carries execution of the game program code.

FIG. 8 illustrates the available game play options 810 selectable with the third button deck 120C of FIG. 7. As similarly discussed herein with respect to FIG. 6, each row 821-825 represents a selection of an arrangement of symbol positions 331-350 (see, FIG. 3). Specifically, first row 821 corresponds to a selection of a 3×5 arrangement of symbol positions for a wager of 1 credit, as selected by virtual button 531 in FIG. 7; second row 622 corresponds to a selection of a 4×5 arrangement for a wager of 2 credits, as selected by virtual button 532 in FIG. 7; third row 623 corresponds to a selection of a 5×5 arrangement for a wager of 3 credits, as selected by virtual button 533 in FIG. 7; fourth row 624 corresponds to a selection of a 6×5 arrangement for a wager of 5 credits, as selected by virtual button 534 in FIG. 7; and fifth row 625 corresponds to a selection of a 7×5 arrangement for a wager of 10 credits, as selected by virtual button 535 in FIG. 7.

In the example of FIG. 8, each column 831-835 represents a different pay line multiplier. The first column 831 corresponds to virtual button 741 of third button deck 120C (see, FIG. 7) and to a first pay line multiplier having a factor of one. Accordingly, for the option corresponding to first column 831, first row 821, one (1) pay line will be evaluated; for first column 831, second row 822, two (2) pay lines will be evaluated; for first column 831, third row 823, three (3) pay lines will be evaluated; for first column 831, fourth row 824, five (5) pay lines will be evaluated; and for first column 831, fifth row 825, ten (10) pay lines will be evaluated.

The second column 832 corresponds to virtual button 742 of third button deck 120C and to a second pay line multiplier having a factor of five. Accordingly, for the option corresponding to second column 832, first row 821, five (5) pay lines will be evaluated; for second column 831, second row 822, ten (10) pay lines will be evaluated; for second column 832, third row 823, fifteen (15) pay lines will be evaluated; for second column 832, fourth row 824, twenty-five (25) pay lines will be evaluated; and for second column 832, fifth row 825, fifty (50) pay lines will be evaluated.

The third column 833 corresponds to virtual button 743 of third button deck 120C and to a third pay line multiplier having a factor of ten. Accordingly, for the option corresponding to third column 833, first row 821, ten (10) pay lines will be evaluated; for third column 833, second row 822, twenty (20) pay lines will be evaluated; for third column 833, third row 823, thirty (30) pay lines will be evaluated; for third column 833, fourth row 824, fifty (50) pay lines will be evaluated; and for third column 833, fifth row 825, one hundred (100) pay lines will be evaluated.

The fourth column 834 corresponds to virtual button 744 of third button deck 120C and to a fourth pay line multiplier having a factor of fifteen. Accordingly, for the option corresponding to fourth column 834, first row 821, fifteen (15) pay lines will be evaluated; for fourth column 834, second row 822, thirty (30) pay lines will be evaluated; for fourth column 834, third row 823, forty-five (45) pay lines will be evaluated; for fourth column 834, fourth row 824, seventy-five (75) pay lines will be evaluated; and for fourth column 834, fifth row 825, one hundred-fifty (150) pay lines will be evaluated.

The fifth column 835 corresponds to virtual button 745 of third button deck 120C and to a fifth pay line multiplier having a factor of twenty. Accordingly, for the option corresponding to fifth column 835, first row 821, twenty (20) pay lines will be evaluated; for fifth column 835, second row 822, forty (40) pay lines will be evaluated; for fifth column 835, third row 823, sixty (60) pay lines will be evaluated; for fifth column 835, fourth row 824, one hundred (100) pay lines will be evaluated; and for fifth column 835, fifth row 825, two hundred (200) pay lines will be evaluated.

It will be observed that this example enables selection of varied numbers of pay lines and symbol position arrangements but includes the option to select the same number of pay lines for some of the different symbol position arrangements.

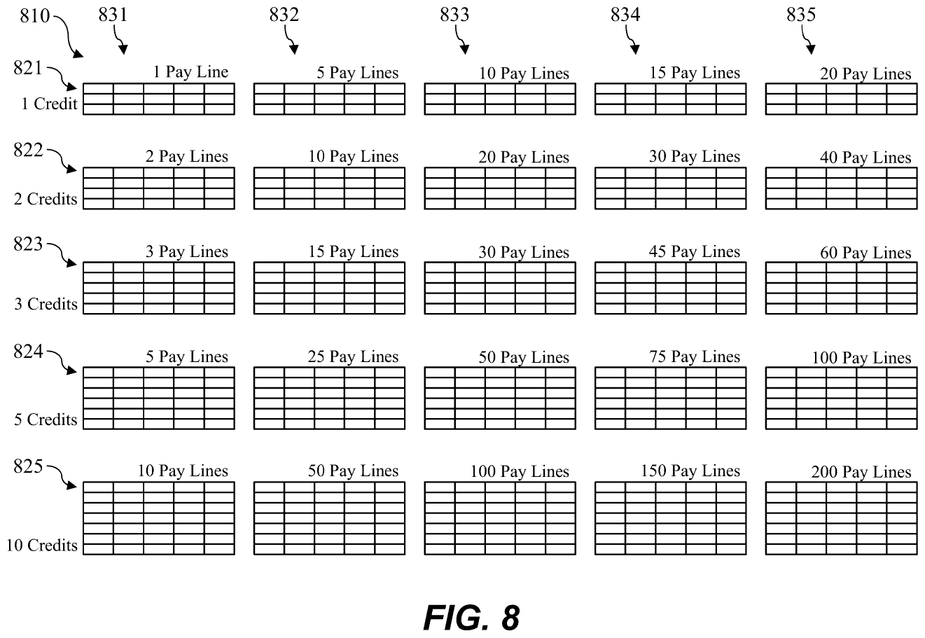

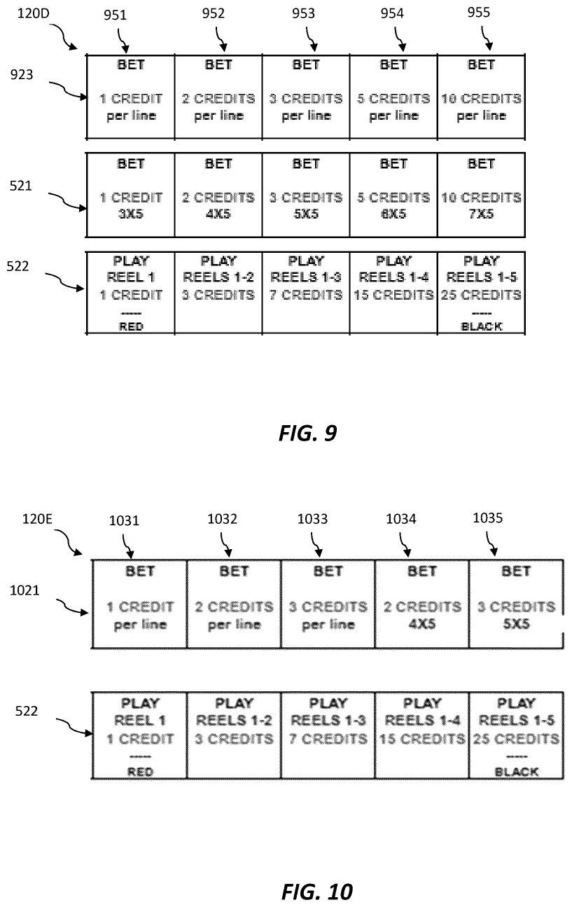

FIG. 9 is a schematic diagram of a fourth button deck 120D, including a third set 923 of five virtual buttons 951-955 in addition to the two sets 521, 522 of five virtual buttons 531-535, 541-545, as previously shown and discussed herein with respect to FIG. 5. In the example, each virtual button 951-955 of third set 923 corresponds to a selection of a third, distinct game play option including different bet multipliers. Virtual button 951 corresponds to a one credit bet multiplier, virtual button 952 corresponds to a two credits bet multiplier, virtual button 953 corresponds to a three credits bet multiplier, virtual button 954 corresponds to a five credits bet multiplier, and virtual button 955 corresponds to a ten credits bet multiplier. In this example, the player selects one game play option from each set 521, 522, 923 of virtual buttons 531-535, 541-545, 951-955. The total amount wagered and deducted from the credit meter is determined by multiplying the credit value of each option. Accordingly, the third set of virtual buttons enable a wider range of wagers relative to FIG. 5, in this example, ranging from 1 to 2500 credits.

FIG. 10 is a schematic diagram of a fifth button deck 120E, including two sets 1021, 522, of five virtual buttons 541-545, 1031-1035. The player makes one selection of game play options from each set 1021, 522. In an example, the second set 522 of virtual buttons 541-545 corresponds to selecting different number of reels to be evaluated and offers the same options as shown in FIG. 5 for the same wager amounts. The first set 1021 of virtual buttons 1031-1035 of button deck 120E has three virtual buttons 1031-1033 corresponding to different bet multipliers that apply to a base arrangement of symbol positions (e.g., 3×5 arrangement of symbol positions) and two virtual buttons 1034, 1035 corresponding to other arrangements of symbol positions. In the example, virtual button 1031 corresponds to a bet multiplier of one credit for the base arrangement; virtual button 1032 corresponds to a bet multiplier of two credits for the base arrangement; virtual button 1033 corresponds to a bet multiplier of three credits for the base arrangement; virtual button 1034 corresponds to a 4×5 arrangement for a wager of two credits; and virtual button 1035 corresponds to a 5×5 arrangement for a wager of three credits.

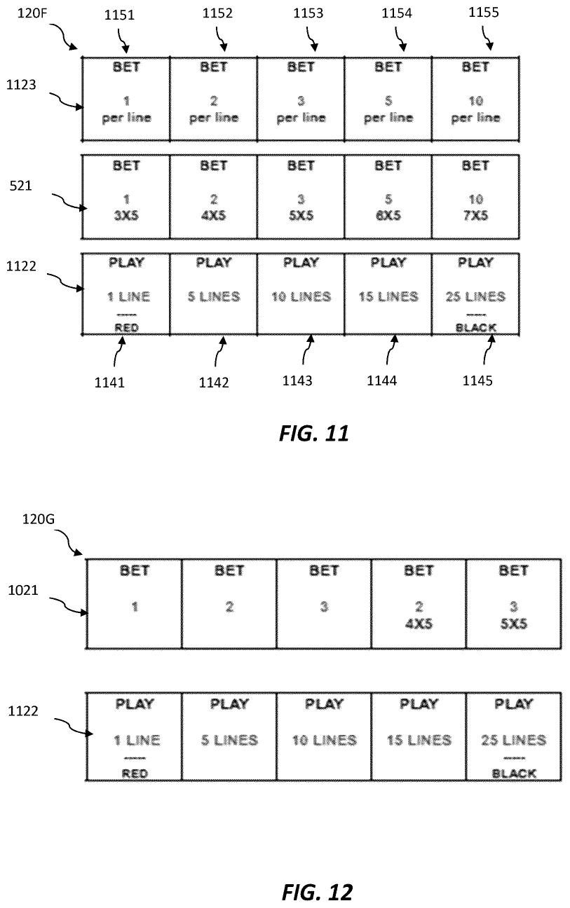

FIG. 11 is a schematic diagram of a sixth button deck 120F, including three sets 521, 1122, 1123 of five virtual buttons 531-535, 1141-1145, 1151-1155. The virtual button deck 120F modifies the button deck 120C of FIG. 7 in a similar way to which the button deck 120D modifies the second button deck 120B of FIG. 5 with the addition of a set of virtual buttons 1151-1155 corresponding to multipliers that apply per line. In this example, each virtual button 1151-1155 of third set 1123 corresponds to a different bet multiplier, namely, virtual button 1151 corresponds to a one credit per line bet multiplier, virtual button 1152 corresponds to a two credits per line bet multiplier, virtual button 1153 corresponds to a three credits per line bet multiplier, virtual button 1154 corresponds to a five credits per line bet multiplier, and virtual button 1155 corresponds to a ten credits per line bet multiplier.

In the example shown in FIG. 11, the different numbers of pay lines that are selectable via second set 1122 of virtual buttons 1141-1145 are slightly different to those of FIG. 7. Specifically, virtual button 1141 corresponds to one pay line per credit wagered on the selected arrangement; virtual button 1142 corresponds to two pay lines per credit wagered on the selected arrangement; virtual button 1143 corresponds to ten pay lines per credit wagered on the selected arrangement; virtual button 1144 corresponds to fifteen pay lines per credit wagered on the selected arrangement; and virtual button 1145 corresponds to twenty-five pay lines per credit wagered on the selected arrangement.

FIG. 12 is schematic diagram of a seventh button deck 120G which has two sets 1021, 1122 of virtual buttons where a first set 1021 is the same as first set 1021 of virtual buttons from fifth button deck 120E of FIG. 10, and a second set 1122 is the same as second set 1122 of virtual buttons from sixth button deck 120F of FIG. 11.

Other button decks can be devised based on the examples given above.

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

What is claimed is:

1. A gaming device comprising:
at least one electronic display;
an input device including:
a first set of input elements operable to select a first game play option, and
a second set of input elements operable to select a second game play option, the second game play option distinct from the first game play option; and
a game controller in communication with the at least one electronic display and the input device, the game controller including at least one processor, and a memory device storing instructions that, when executed by the at least one processer, cause the game controller to:
control the at least one electronic display to display an evaluation area including a plurality of symbol positions based on one of the selected, first game play option or the selected, second game play option;
select symbols, based on symbol data in the memory device, for display in one of the plurality of the symbol positions included in the evaluation area; and
evaluate the selected symbols for winning combinations based on one of the selected, first game play option or the selected, second game play option.

2. The gaming device of claim 1, wherein the first game play option selected by the first set of input elements includes:
a first arrangement of the plurality of symbol positions including a first number of rows of the plurality of symbol positions; and
a second arrangement of the plurality of symbol positions including a second number of rows of the plurality of symbol positions, the second number of rows of the plurality of symbol positions is greater than the first number of rows of the plurality of symbol positions.

3. The gaming device of claim 2, wherein:
the first arrangement of the plurality of symbol positions further includes a first number of columns of the plurality of symbol positions, and
the second arrangements of the plurality of symbol positions further includes a second number of columns of the plurality of symbol positions, the second number of columns of the plurality of symbol positions is greater than the first number of columns of the plurality of symbol positions.

4. The gaming device of claim 2, wherein the second game play option selected by the second set of input elements includes:
a first win evaluation including a first number of reels formed from the plurality of symbol positions of the first arrangement or the second arrangement; and
a second win evaluation including a second number of reels formed from the plurality of symbol positions of the first arrangement or the second arrangement, the second number of reels formed from the plurality of symbol positions is greater than the first number of reels formed from the plurality of symbol positions.

5. The gaming device of claim 4, wherein in response to evaluating the selected symbols for the winning combinations based on the selected, second game play option, the instructions stored in the memory device, when executed by the processor, further cause the game controller to:
compare each of the plurality of symbol positions forming the first number of reels to reference symbol positions included in the plurality of symbol positions.

6. The gaming device of claim 5, wherein in response to evaluating the selected symbols for the winning combinations based on the selected, second game play option, the instructions stored in the memory device, when executed by the processor, further cause the game controller to one of:
compare each of the plurality of symbol positions forming the second number of reels to the reference symbol positions included in the plurality of symbol positions, or
evaluate each of the plurality of symbol positions forming the second number of reels, in response to the second number of reels including every symbol position of the plurality of symbol positions.

7. The gaming device of claim 2, wherein the second game play option selected by the second set of input elements includes:
a first number of pay lines for the plurality of symbol positions of the first arrangement or the second arrangement; and
a second number of pay lines for the plurality of symbol positions of the first arrangement or the second arrangement, the second number of pay lines for the plurality of symbol positions is greater than the first number of pay lines for the plurality of symbol positions.

8. The gaming device of claim 2, wherein the second game play option selected by the second set of input elements includes:
a first bet multiplier for the plurality of symbol positions of the first arrangement or the second arrangement; and
a second bet multiplier for the plurality of symbol positions of the first arrangement or the second arrangement, the second bet multiplier for the plurality of symbol positions is greater than the first bet multiplier for the plurality of symbol positions.

9. The gaming device of claim 1, wherein the first game play option selected by a first input element of the first set of input elements includes a bet multiplier for the plurality of symbol positions, and wherein the first game play option selected by a second input element of the first set of input elements includes an arrangement of the plurality of symbol positions including:
a number of rows of the plurality of symbol positions, and
a number of columns of the plurality of symbol positions.

10. The gaming device of claim 1, wherein the input device is formed as a touch panel associated with the at least one electronic display, and each input element of the first set and the second set is formed as a virtual button.

11. The gaming device of claim 1, wherein the input device further comprises:
a third set of input elements operable to select a third game play option, the third game play option distinct from the first game play option and the second game play option.

12. A method of electronic gaming implemented on an electronic gaming device, the method comprising:
displaying, via at least one electronic display of the electronic gaming device, an evaluation area including a plurality of symbol positions based on one of a selected, first game play option or a selected, second game play option,
wherein the second game play option is distinct from the first game play option;
displaying symbols, based on symbol data, in one of the plurality of the symbol positions included in the evaluation area; and
evaluating the selected symbols for winning combinations based on one of the selected, first game play option or the selected, second game play option.

13. The method of claim 12, wherein the displaying of the evaluation area including the plurality of symbol positions based on the selected, first game play option further includes one of:
displaying a first arrangement of the plurality of symbol positions, the first arrangement including:
a first number of rows of the plurality of symbol positions, and
a first number of columns of the plurality of symbol positions; or
displaying a second arrangement of the plurality of symbol positions, the second arrangement including:
a second number of rows of the plurality of symbol positions, the second number of rows of the plurality of symbol positions is greater than the first number of rows of the plurality of symbol positions, and
a second number of columns of the plurality of symbol positions, the second number of columns of the plurality of symbol positions is greater than the first number of columns of the plurality of symbol positions.

14. The method of claim 13, wherein the evaluating of the selected symbols for the winning combinations based on the selected, second game play option includes one of:
comparing each of the plurality of symbol positions forming a first number of reels to reference symbol positions included in the plurality of symbol positions, the first number of reels formed from the plurality of symbol positions of the first arrangement or the second arrangement;
comparing each of the plurality of symbol positions forming a second number of reels to the reference symbol positions included in the plurality of symbol positions, the second number of reels formed from the plurality of symbol positions of the first arrangement or the second arrangement,
wherein the second number of reels formed from the plurality of symbol positions is greater than the first number of reels formed from the plurality of symbol positions; or
evaluate each of the plurality of symbol positions forming the second number of reels, in response to the second number of reels including every symbol position of the plurality of symbol positions.

15. The method of claim 13, wherein the evaluating of the selected symbols for the winning combinations based on the selected, second game play option includes one of:
evaluating a first number of pay lines for the plurality of symbol positions of the first arrangement or the second arrangement; or
evaluating a second number of pay lines for the plurality of symbol positions of the first arrangement or the second arrangement, the second number of pay lines for the plurality of symbol positions is greater than the first number of pay lines for the plurality of symbol positions.

16. The method of claim 13, wherein the evaluating of the selected symbols for winning combinations based on the selected, second game play option includes one of:
evaluating a first bet multiplier for the plurality of symbol positions of the first arrangement or the second arrangement, or
evaluating a second bet multiplier for the plurality of symbol positions of the first arrangement or the second arrangement, the second bet multiplier for the plurality of symbol positions is greater than the first bet multiplier for the plurality of symbol positions.

17. A non-transitory computer-readable storage medium with symbol data and instructions stored thereon that, in response to execution by at least one processor, cause the at least one processor to:
control at least one electronic display to display an evaluation area including a plurality of symbol positions based on one of a selected, first game play option or a selected, second game play option,
wherein the second game play option is distinct from the first game play option;
control the at least one electronic display to display symbols, based on the symbol data, in one of the plurality of the symbol positions included in the evaluation area; and
evaluate the selected symbols for winning combinations based on one of the selected, first game play option or the selected, second game play option.

18. The non-transitory computer-readable storage medium of claim 17, wherein the controlling the at least one electronic display to display the evaluation area including the plurality of symbol positions based on the selected, first game play option further causes the at least one processor to one of:
control the at least one electronic display to display a first arrangement of the plurality of symbol positions, the first arrangement including:
a first number of rows of the plurality of symbol positions, and
a first number of columns of the plurality of symbol positions; or
control the at least one electronic display to display a second arrangement of the plurality of symbol positions, the second arrangement including:
a second number of rows of the plurality of symbol positions, the second number of rows of the plurality of symbol positions is greater than the first number of rows of the plurality of symbol positions, and
a second number of columns of the plurality of symbol positions, the second number of columns of the plurality of symbol positions is greater than the first number of columns of the plurality of symbol positions.

19. The non-transitory computer-readable storage medium of claim 18, wherein the evaluating of the selected symbols for the winning combinations based on the selected, second game play option further causes the at least one processor to one of:
compare each of the plurality of symbol positions forming a first number of reels to reference symbol positions included in the plurality of symbol positions, the first number of reels formed from the plurality of symbol positions of the first arrangement or the second arrangement;
compare each of the plurality of symbol positions forming a second number of reels to the reference symbol positions included in the plurality of symbol positions, the second number of reels formed from the plurality of symbol positions of the first arrangement or the second arrangement,
wherein the second number of reels formed from the plurality of symbol positions is greater than the first number of reels formed from the plurality of symbol positions; or
evaluate each of the plurality of symbol positions forming the second number of reels, in response to the second number of reels including every symbol position of the plurality of symbol positions.

20. The non-transitory computer-readable storage medium of claim 18, wherein the evaluating of the selected symbols for the winning combinations based on the selected, second game play option further causes the at least one processor to one of:
evaluate a first number of pay lines for the plurality of symbol positions of the first arrangement or the second arrangement; or
evaluate a second number of pay lines for the plurality of symbol positions of the first arrangement or the second arrangement, the second number of pay lines for the plurality of symbol positions is greater than the first number of pay lines for the plurality of symbol positions.
